(19) United States
(12) Patent Application Publication
(10) Pub. No.: US 2026/0062004 A1
(43) Pub. Date: Mar. 5, 2026

(54) DRIVING ASSISTANCE APPARATUS FOR VEHICLE

(71) Applicant: SUBARU CORPORATION, Tokyo (JP)

(72) Inventors: Tetsuo SHIRAISHI, Tokyo (JP); Masatoshi MINAKAWA, Tokyo (JP); Yuki SASAKI, Tokyo (JP)

(21) Appl. No.: 19/246,931

(22) Filed: Jun. 24, 2025

(30) Foreign Application Priority Data
Sep. 3, 2024 (JP) 2024-151765

(51) Int. Cl. B60W 30/165

(52) U.S. Cl. CPC B60W 30/165; B60W 2552/10; B60W 2554/4041; B60W 2720/106; B60W 2754/30

(57) ABSTRACT

A driving assistance apparatus for a vehicle includes a traveling environment information acquirer that acquires information regarding traveling environment ahead of the vehicle; and a vehicle following controller that, when a preceding vehicle most previously traveling in front of the vehicle is detected based on the information regarding traveling environment, perform a vehicle following control with respect to the preceding vehicle. The vehicle following controller includes a registration unit for no-passing target vehicles that performs regarding the preceding vehicle registration as a no-passing target vehicle based on the information regarding traveling environment when the preceding vehicle has departed to a no-passing target lane side or the vehicle has departed to a no-passing lane side, and a no-passing target following controller that performs the vehicle following control with respect to the no-passing target vehicle when the registration unit for no-passing target vehicles has performed the registration as the no-passing target vehicle.

### CROSS-REFERENCE TO RELATED APPLICATIONS

The present application claims priority from Japanese Patent Application No. 2024-151765 filed on September 3, 2024, the entire contents of which are hereby incorporated by reference.

### BACKGROUND

The disclosure relates to a driving assistance apparatus for a vehicle.

Various driving assistance apparatuses have recently been proposed for vehicles to reduce a load on a driver who drives a vehicle and enable the driver to drive comfortably and safely, and some of the driving assistance apparatuses have already been put into practical use. A known type of driving assistance apparatus is an adaptive cruise control (ACC) apparatus, which is a cruise control apparatus having an automatic following-distance control. In the ACC, the presence or absence of a preceding vehicle traveling in the same lane is checked using, for example, a vehicle-mounted camera, various radar sensors, or a forward recognition sensor that includes a combination of such devices, which is mounted in or on a vehicle.

Upon detecting a preceding vehicle traveling in the same lane, the ACC performs registration of the preceding vehicle as a target to follow and causes the vehicle including the ACC apparatus to follow the preceding vehicle while maintaining a predetermined target following distance. Upon failing to detect a preceding vehicle to follow ahead in the same lane, the ACC causes the vehicle including the ACC apparatus to travel at a set vehicle speed that has been set by a driver who drives the vehicle (for example, Japanese Unexamined Patent Application Publication (JP-A) No. 2023-97127).

Thus, when the preceding vehicle to follow is no longer detected as a result of a lane change of the preceding vehicle or the vehicle including the ACC apparatus, the vehicle including the ACC apparatus is accelerated to the set vehicle speed.

### SUMMARY

An aspect of the disclosure provides a driving assistance apparatus for a vehicle including a traveling environment information acquirer and a vehicle following controller. The traveling environment information acquirer is configured to acquire information regarding traveling environment ahead of the vehicle. The vehicle following controller is configured to, when a preceding vehicle most previously traveling in front of the vehicle in a same lane as the vehicle is detected based on the information regarding traveling environment acquired by the traveling environment information acquirer, perform a vehicle following control with respect to the preceding vehicle. The vehicle following controller includes a registration unit for no-passing target vehicles and a no-passing target following controller. The registration unit for no-passing target vehicles is configured to perform, regarding the preceding vehicle, registration as a no-passing target vehicle when one or both of first and second states are detected based on the information regarding traveling environment acquired by the traveling environment information acquirer. The first state is that the preceding vehicle has departed to a no-passing target lane side, and the second state is that the vehicle has departed to a no-passing lane side. The no-passing target following controller is configured to perform the vehicle following control with respect to the no-passing target vehicle when the registration unit for no-passing target vehicles has performed the registration as the no-passing target vehicle.

An aspect of the disclosure provides a driving assistance apparatus for a vehicle including circuitry. The circuitry is configured to acquire information regarding traveling environment ahead of the vehicle. The circuitry is configured to, when a preceding vehicle most previously traveling in front of the vehicle in a same lane as the vehicle is detected based on the information regarding traveling environment, perform a vehicle following control with respect to the preceding vehicle. The circuitry is further configured to perform, regarding the preceding vehicle, registration as a no-passing target vehicle when one or both of first and second states are detected based on the information regarding traveling environment. The first state is that the preceding vehicle has departed to a no-passing target lane side, and the second state is that the vehicle has departed to a no-passing lane side. The circuitry is further configured to perform the vehicle following control with respect to the no-passing target vehicle when the registration as the no-passing target vehicle has been performed.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic configuration diagram of a driving assistance apparatus;

FIG. 2A is a flowchart illustrating a vehicle following control routine (part 1);

FIG. 2B is a flowchart illustrating the vehicle following control routine (part 2);

FIG. 3A is an explanatory diagram illustrating a situation in which a vehicle to follow becomes a no-passing parallel traveling vehicle due to a lane change of a vehicle including an ACC;

FIG. 3B is an explanatory diagram illustrating a situation in which a vehicle to follow becomes a no-passing target vehicle due to a departure of the vehicle including the ACC to an adjacent lane;

FIG. 4A is an explanatory diagram illustrating a situation in which a vehicle to follow becomes a no-passing parallel traveling vehicle due to a lane change of the vehicle to follow;

FIG. 4B is an explanatory diagram illustrating a situation in which a vehicle to follow becomes a no-passing target vehicle due to a departure of the vehicle to follow to an adjacent lane;

FIG. 5 is an explanatory diagram illustrating a vehicle following control performed when a lane boundary line changes from a lane boundary line permitting a lane change to a lane boundary line prohibiting a lane change; and

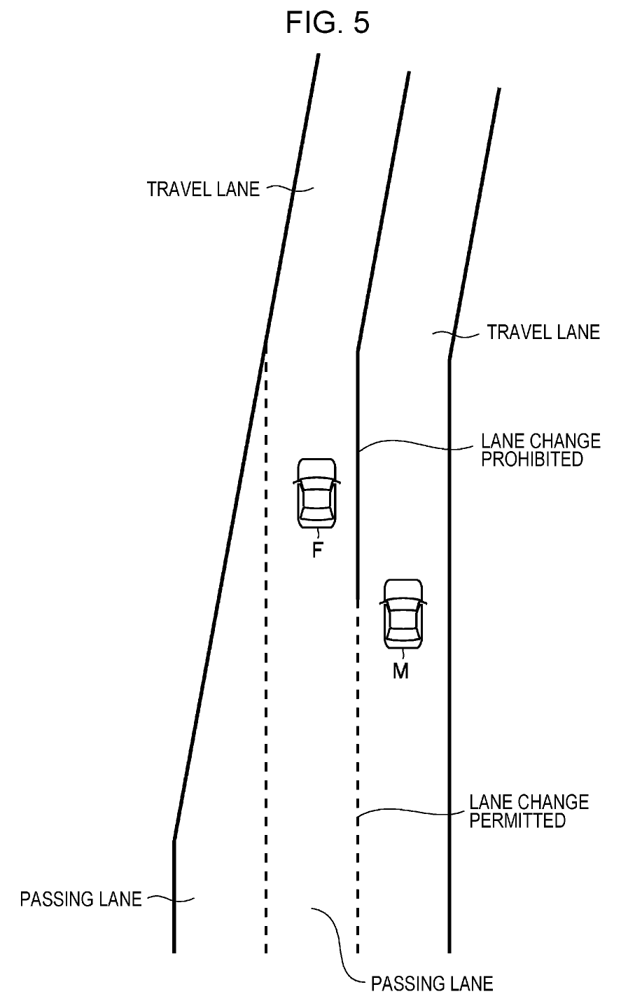

FIG. 6 is a flowchart illustrating a vehicle following control routine according to a modification.

### DETAILED DESCRIPTION

In countries where right-hand traffic is stipulated, the first lane to the right is a travel lane and a lane to the left is a passing lane. When there are two or more passing lanes, a lane to the left is a higher-speed lane.

In some countries where right-hand traffic is stipulated, passing a vehicle traveling in the left lane is legally prohibited. For example, when a vehicle including an ACC apparatus is traveling in the first lane under the ACC, the ACC attempts to cause the vehicle to travel at a set vehicle speed if no preceding vehicle is detected ahead in the travel lane.

In this situation, according to a technique disclosed in JP-A No. 2023-97127, when a vehicle traveling in parallel (parallel traveling vehicle) is detected ahead in a passing lane adjacent to the travel lane in which the vehicle including the ACC apparatus is traveling, the vehicle including the ACC apparatus may pass the parallel traveling vehicle if the vehicle speed of the parallel traveling vehicle is slower than the set vehicle speed.

Thus, in countries where right-hand traffic is stipulated and passing a vehicle traveling in the left lane is legally prohibited, an ACC apparatus is often provided with a function configured to prohibit passing a vehicle traveling in the left lane.

However, when the preceding vehicle to follow changes lanes or the vehicle including the ACC apparatus changes lanes, the preceding vehicle to follow disappears in the ACC. Accordingly, the ACC apparatus attempts to accelerate the vehicle including the ACC apparatus to the set vehicle speed until detecting the parallel traveling vehicle (preceding vehicle after a lane change) traveling in the adjacent lane to the left even if the ACC apparatus is provided with the function configured to prohibit passing a vehicle traveling in the left lane. When the ACC apparatus detects the parallel traveling vehicle traveling in the adjacent lane to the left, the function configured to prohibit passing a vehicle is activated to rapidly decelerate the vehicle including the ACC apparatus.

The driver of the vehicle including the ACC apparatus recognizes that the vehicle including the ACC apparatus is traveling in the right lane adjacent to the lane of the preceding vehicle (parallel traveling vehicle) as a result of the lane change of the vehicle including the ACC apparatus or the preceding vehicle and recognizes that passing the parallel traveling vehicle is prohibited. Thus, the driver feels discomfort when the ACC temporarily accelerates the vehicle including the ACC apparatus due to the disappearance of the preceding vehicle and then rapidly decelerates the vehicle due to the detection of the parallel traveling vehicle, which is a no-passing target vehicle.

It is desirable to provide a driving assistance apparatus for a vehicle capable of reducing discomfort felt by the driver by avoiding unnecessary acceleration/deceleration caused during a period between the disappearance of a preceding vehicle and the detection of the preceding vehicle as a no-passing target vehicle when the vehicle including the ACC apparatus or the preceding vehicle followed by the vehicle including the ACC apparatus moves to an adjacent lane.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

In the embodiment, a case where a vehicle travels on a road where right-hand traffic is stipulated will be described as an example. Thus, on a road where left-hand traffic is stipulated, the terms "left" and "right" are to be interchanged.

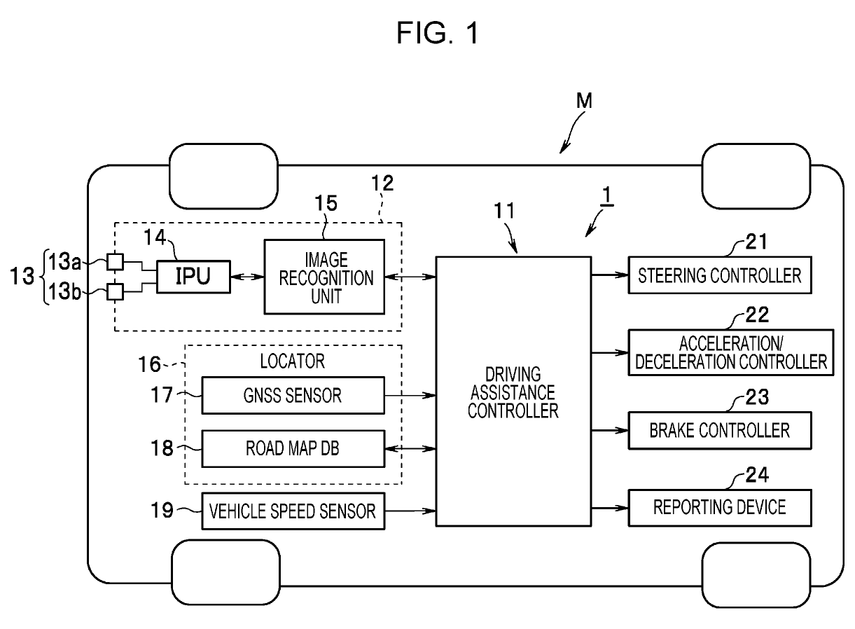

A driving assistance apparatus 1 is mounted on a vehicle (a vehicle including an ACC apparatus) M illustrated in FIG. 1. The driving assistance apparatus 1 includes a driving assistance controller 11. The driving assistance controller 11 includes a microcontroller including a central processing unit (CPU), a random access memory (RAM), a read-only memory (ROM), a rewritable nonvolatile memory (a flash memory or an electrically erasable programmable read-only memory (EEPROM)), and peripheral devices. The ROM stores a program, fixed data, and the like necessary for the CPU to execute each process. The RAM is provided as a work area for the CPU and temporarily stores various kinds of data for the CPU. The CPU is also called a microprocessor unit (MPU) or a processor. A graphics processing unit (GPU) or a graph streaming processor (GSP) may be used instead of the CPU. Alternatively, the CPU, the GPU, and the GSP may be selectively combined and used.

A forward recognition sensor 12 configured to serve as a traveling environment information acquirer in one embodiment, a locator 16, and a vehicle speed sensor 19 are connected to the input side of the driving assistance controller 11.

The forward recognition sensor 12 is a camera unit in the present embodiment. The camera unit includes a stereo camera 13, an image processing unit (IPU) 14 and an image recognition unit 15. The stereo camera 13 includes a main camera 13a and a sub camera 13b. For example, the main camera 13a and the sub camera 13b are disposed a predetermined baseline length apart in the vehicle interior of the vehicle including the ACC apparatus, located at positions symmetrical about the center in the vehicle-width direction, and pointing forward (in the direction of travel).

Each of the cameras 13a and 13b has a color imaging device such as a charge-coupled device (CCD) image sensor or a complementary metal oxide semiconductor (CMOS) image sensor. The cameras 13a and 13b are configured to acquire two images of the surrounding environment in a predetermined range ahead of the vehicle to generate a stereo image, and the two images are acquired from different viewpoints at predetermined imaging cycles synchronized with each other.

The cameras 13a and 13b are both configured to capture traveling environment ahead of a vehicle M, and the IPU 14 is configured to perform predetermined image processing on information regarding the traveling environment and transmit the information to the image recognition unit 15. The image recognition unit 15 is configured to perform processing based on known technology, such as template matching processing and feature point detection processing, on the image data processed by the IPU 14 to recognize vehicles in the surroundings including a preceding vehicle and a parallel traveling vehicle, three dimensional objects such as guardrails extending along the road, and lane boundary lines demarcating lanes together with line types and the like of the lane boundary lines.

Various kinds of information recognized by the image recognition unit 15 are output to the driving assistance controller 11. The camera unit employed as the forward recognition sensor 12 is an example of a device configured to recognize traveling environment ahead of the vehicle M. In place of the camera unit, a device such as a millimeter wave radar, a sound wave radar, or a light detection and ranging (LiDAR) may be used as the forward recognition sensor 12 as long as the forward recognition sensor 12 is able to recognize traveling environment ahead of the vehicle M. Further, these devices may be combined with a monocular camera and may be used as the forward recognition sensor 12.

The locator 16 includes a global navigation satellite system (GNSS) sensor 17 and a road map database (road map DB) 18. The GNSS sensor 17 is configured to receive positioning signals transmitted from multiple positioning satellites and measure the position (such as latitude, longitude, and altitude) of the vehicle M. The road map DB 18 is a large-capacity storage medium such as a hard disk drive (HDD) or a solid state drive (SSD). Road map information is stored in the road map DB 18.

The locator 16 is configured to perform map matching of the position information of the vehicle M positioned by the GNSS sensor 17 on road map data in the road map DB 18, and estimates the position (current position) of the vehicle M on the road map.

The vehicle speed sensor 19 is configured to detect the speed (vehicle speed) of the vehicle M. The vehicle speed sensor 19 is configured to detect the speed of the vehicle M based on, for example, an average value of wheel speeds detected by wheel speed sensors provided on four wheels.

A steering controller 21, an acceleration/deceleration controller 22, a brake controller 23, and a reporting device 24 are connected to the output side of the driving assistance controller 11.

The steering controller 21 is configured to control steering torque generated by an electric power steering (EPS) motor. The acceleration/deceleration controller 22 is configured to control an output of a drive source such as an engine or an electric motor mounted on the vehicle M. The brake controller 23 is configured to adjust a pressure of brake oil supplied to a brake wheel cylinder provided on each wheel. The brake controller 23 is configured to control a brake force generated in each wheel by adjusting the pressure of brake oil. The reporting device 24 includes a screen and a loudspeaker.

While neither a preceding vehicle to follow nor a parallel traveling vehicle traveling in an adjacent lane is captured during the ACC, the driving assistance controller 11 sets the target vehicle speed to the set vehicle speed. Then, the driving assistance controller 11 causes the acceleration/deceleration controller 22 to perform acceleration/deceleration control on the drive source so that the speed of the vehicle M converges to the target vehicle speed.

In contrast, upon capturing a preceding vehicle F most previously traveling in front of the vehicle M during the ACC, the driving assistance controller 11 checks whether the preceding vehicle F satisfies a condition as a vehicle to follow. When the preceding vehicle F satisfies the condition as a vehicle to follow, the driving assistance controller 11 performs registration of the preceding vehicle F as a vehicle to follow. In the present embodiment, the preceding vehicle F traveling immediately in front of the vehicle M is referred to as a vehicle to follow (F) for convenience.

The driving assistance controller 11 is configured to set a target vehicle speed to cause the vehicle M to follow the vehicle to follow (F), which has been registered, while maintaining a target following distance that is set in advance.

The driving assistance controller 11 is configured to cause the acceleration/deceleration controller 22 to perform acceleration/deceleration control on the drive source so that the speed of the vehicle M converges to the target vehicle speed. Upon determining that the deceleration control by the acceleration/deceleration controller 22 is not sufficient to reduce the speed of the vehicle M, the driving assistance controller 11 causes the brake controller 23 to perform brake control to forcibly reduce the speed of the vehicle M to the target vehicle speed.

The driving assistance controller 11 is also configured to, for example, when the preceding vehicle F, which is a target to follow, has changed lanes or the vehicle M has changed lanes and the preceding vehicle F has consequently become a no-passing target vehicle, which is a vehicle that the vehicle M is not allowed to pass, cause the reporting device 24 to report to the driver the fact that the preceding vehicle F has become a no-passing target vehicle.

The driving assistance controller 11 is also configured to, when the preceding vehicle F, which is a target to follow, has changed lanes or the vehicle M has changed lanes during the ACC, immediately perform registration of the preceding vehicle as a no-passing target vehicle. The driving assistance controller 11 is configured to then perform vehicle following control of causing the vehicle M to follow the no-passing target vehicle, which has been registered.

The driving assistance controller 11 is also configured to perform various kinds of driving assistance controls, such as lane keep assist (LKA) control and lane departure prevention (LDP) control, in addition to the ACC during traveling. In the LKA control and the LDP control, the driving assistance controller 11 outputs a steering command signal to the steering controller 21 and causes the steering controller 21 to perform steering control. Since the LKA control and the LDP control are known, detailed description thereof will be omitted.

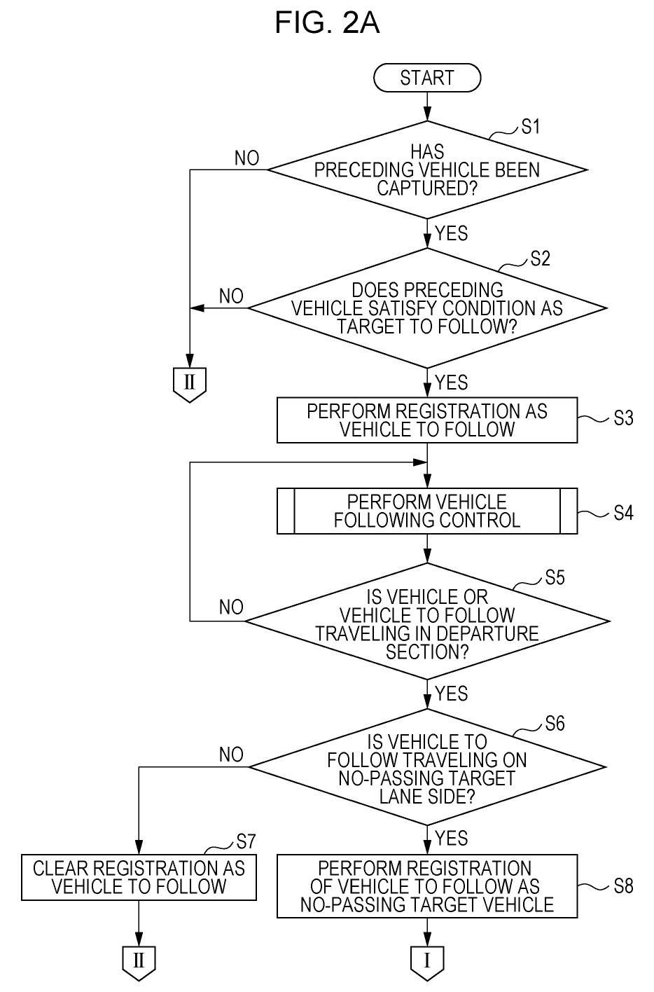

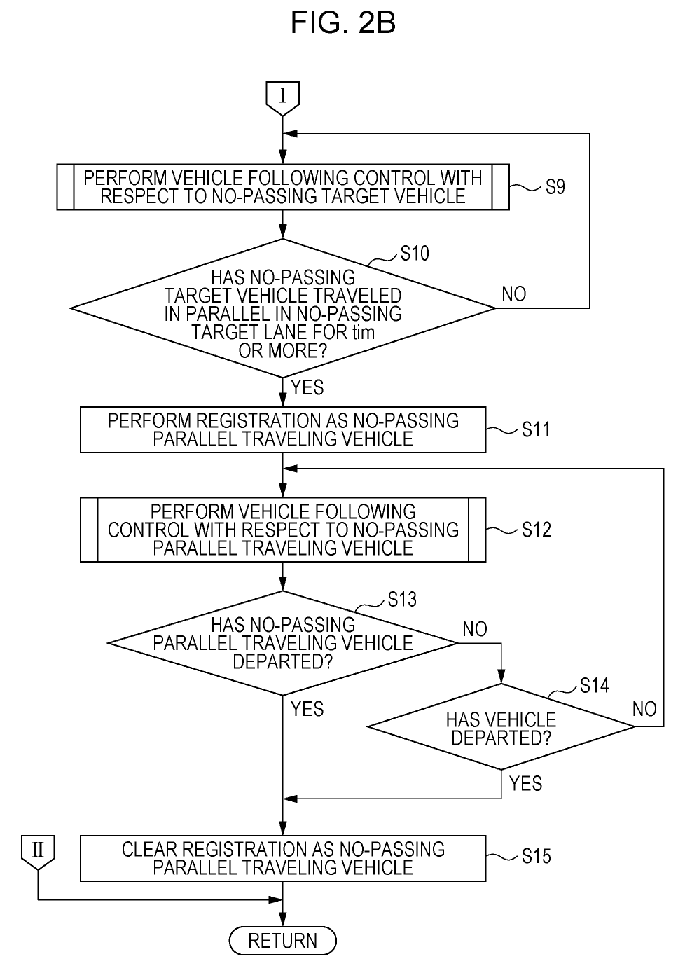

The vehicle following control performed by the driving assistance controller 11 is specifically performed according to a vehicle following control routine illustrated in FIGS. 2A and 2B. This routine is performed in every predetermined calculation cycle after the system is activated. In one embodiment, the process in this routine may serve as a vehicle following controller.

First, the driving assistance controller 11 checks whether the image recognition unit 15 has captured the preceding vehicle F within a predetermined distance (for example, 200 [m]) ahead of the vehicle M (step S1). Upon determining that the image recognition unit 15 has not captured the preceding vehicle F (NO), the driving assistance controller 11 exits the routine. Upon determining that the image recognition unit 15 has captured the preceding vehicle F (YES), the driving assistance controller 11 checks whether the preceding vehicle F satisfies the condition as a target to follow (step S2).

The driving assistance controller 11 determines whether the preceding vehicle F, which is captured by the image recognition unit 15, satisfies the condition as a target to follow, for example, according to the following criteria.

(1) The preceding vehicle F traveling immediately in front of the vehicle M is captured within a predetermined distance ahead of the vehicle M (for example, 150 [m] at a speed of the vehicle M of 130 [km/h]).

(2) The preceding vehicle F is traveling in the same lane as the vehicle M.

(3) The speed of the preceding vehicle F is slower than the speed of the vehicle M.

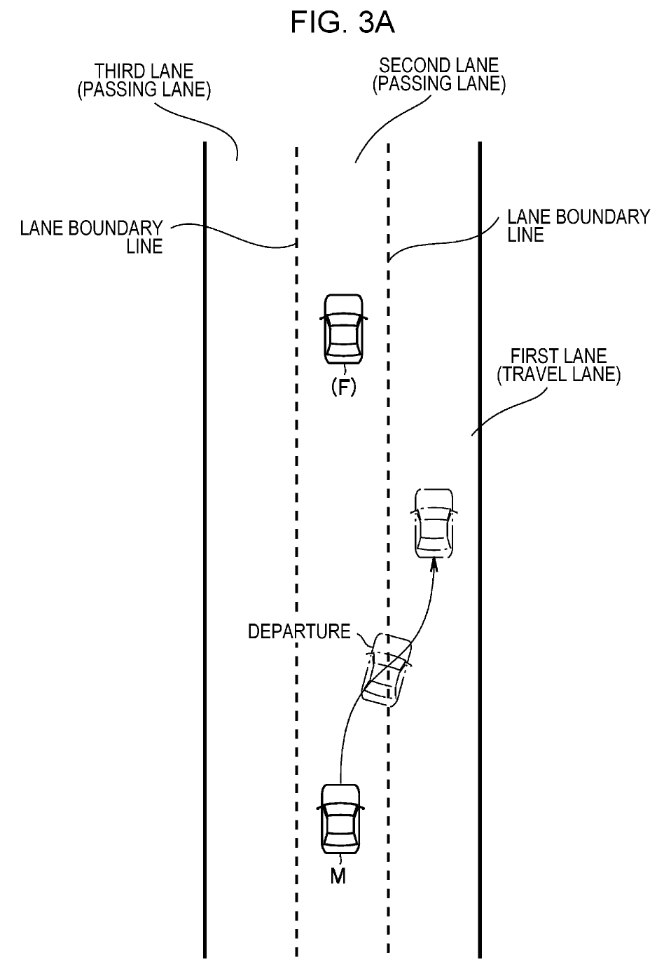

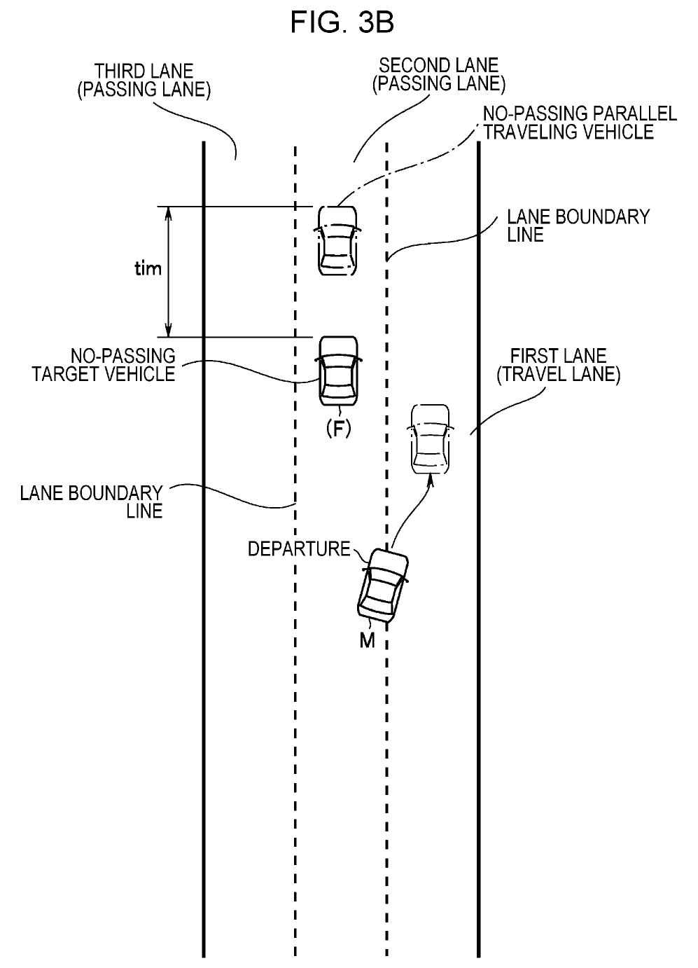

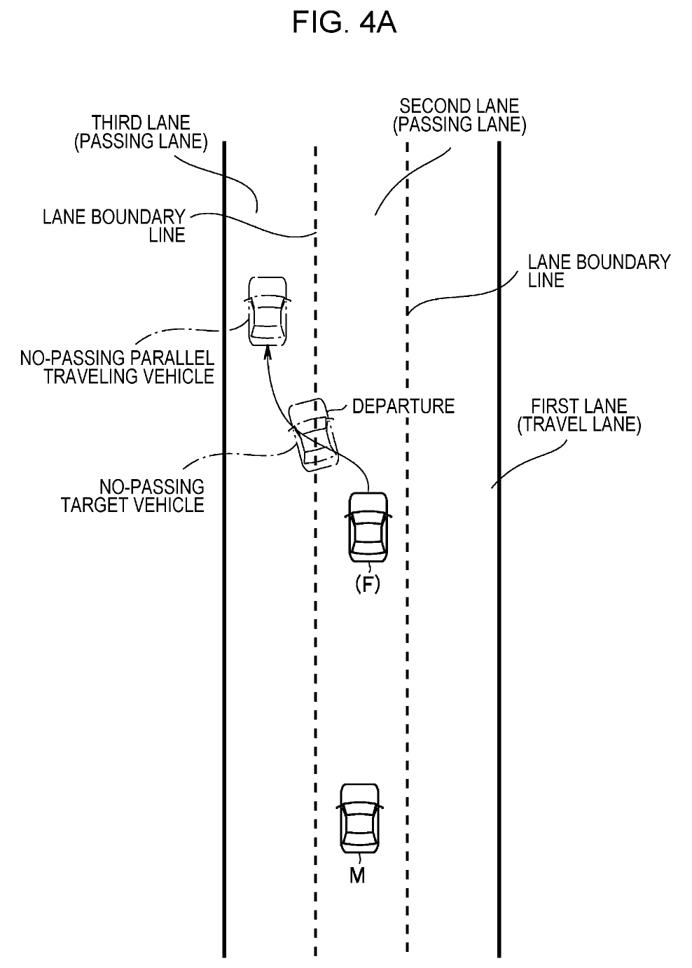

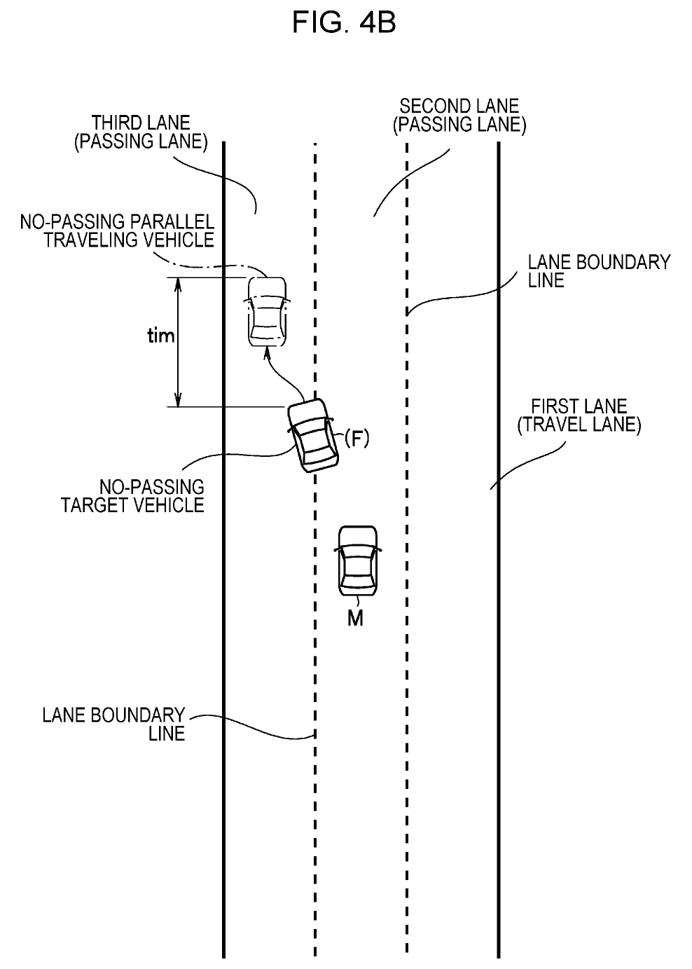

When all of the criteria (1) to (3) are satisfied (YES), the driving assistance controller 11 performs registration of the preceding vehicle F as a vehicle to follow (F) as illustrated in FIGS. 3A and 4A (step S3). In contrast, when one or more of the criteria (1) to (3) are not satisfied (NO), the driving assistance controller 11 exits the routine.

Next, the driving assistance controller 11 performs the ACC to cause the vehicle M to follow the vehicle to follow (F), which has been registered (step S4). That is, the driving assistance controller 11 sets a target vehicle speed to cause the vehicle M to travel while maintaining a predetermined target following distance to the vehicle to follow (F). Then, the driving assistance controller 11 causes the acceleration/deceleration controller 22 to perform acceleration/deceleration control and causes the brake controller 23 to perform brake control so that the speed of the vehicle M converges to the target vehicle speed. The target following distance can be set in advance by the driver within a certain range. Further, the target following distance can be variably set according to the vehicle speed. When the target following distance is variably set according to the vehicle speed, the target following distance becomes shorter as the vehicle speed becomes slower.

Thereafter, the driving assistance controller 11 checks whether the vehicle M or the vehicle to follow (F) is traveling in a departure section (step S5). The departure section begins when the vehicle M or the vehicle to follow (F) starts to change lanes and ends when the lane change is completed. In the present embodiment, as illustrated in FIGS. 3B and 4B, a departure section begins when the vehicle M or the vehicle to follow (F) starts to change the course toward a lane boundary line and ends when the entire vehicle body becomes substantially parallel to the lane boundary line after crossing the lane boundary line. The departure section may, for example, begin when the vehicle body starts to cross the lane boundary line and end when the entire vehicle body crosses the lane boundary line.

The driving assistance controller 11 determines whether the vehicle M or the vehicle to follow (F) is traveling in the departure section based on information recognized by the image recognition unit 15 of the forward recognition sensor 12.

Upon determining that the vehicle M or the vehicle to follow (F) keeps traveling in the lane in which the vehicle M or the vehicle to follow (F) has been traveling (step S5: NO), the driving assistance controller 11 returns to step S4 and continues the vehicle following control. In contrast, upon determining that the vehicle M or the vehicle to follow (F) is traveling in the departure section (step S5: YES), the driving assistance controller 11 checks whether the vehicle to follow (F) is traveling on a no-passing target lane side (step S6). The driving assistance controller 11 determines the position of the vehicle to follow (F) based on the information recognized by the image recognition unit 15 of the forward recognition sensor 12.

When right-hand traffic is stipulated, a no-passing target lane refers to a lane adjacent to the left side of the lane in which the vehicle M is traveling. In such a case, the lane in which the vehicle M is traveling is referred to as a no-passing lane. Accordingly, in FIG. 3A, the second lane in which the vehicle M is traveling is a no-passing lane, and the third lane adjacent to the left side of the second lane is a no-passing target lane. In addition, in FIG. 3B, when the vehicle M departs for the first lane (travel lane), the first lane becomes a no-passing lane, and the second lane (passing lane) becomes a no-passing target lane.

Upon determining that the vehicle to follow (F) is not traveling on the no-passing target lane side (NO), the driving assistance controller 11 clears the registration as the vehicle to follow (F) (step S7) and exits the routine. In contrast, upon determining that the vehicle to follow (F) is traveling on the no-passing target lane side (YES), the driving assistance controller 11 updates registration and performs registration of the vehicle to follow (F) as a no-passing target vehicle (step S8). In one embodiment, the process in this step may serve as a registration unit for no-passing target vehicles.

Thereafter, the driving assistance controller 11 performs the ACC to cause the vehicle M to follow the no-passing target vehicle while keeping traveling in the lane in which the vehicle M is currently traveling (step S9). In one embodiment, the process in this step may serve as a no-passing target following controller.

In addition, the deceleration that is set in the ACC when the vehicle M approaches the no-passing target vehicle is smaller than the deceleration that is normally set in the ACC. This is because there is no possibility of a rear-end collision even if the deceleration timing is delayed since the no-passing target vehicle is traveling in the adjacent lane. By reducing the deceleration, the driver does not feel discomfort due to rapid deceleration. Further, it is possible to reduce the discomfort felt by the driver by reducing the deceleration when an object such as a roadside object is erroneously recognized as a parallel traveling vehicle and erroneous braking occurs in a low-accuracy parallel traveling vehicle identification process, which is a process of identifying a parallel traveling vehicle.

The target following distance that is set by the ACC in this situation is the minimum distance among the target following distances that can be set in step S4. By setting the target following distance to a small value, the target following distance becomes short when a target to follow changes from the vehicle to follow (F) to the no-passing target vehicle. Then, the driving assistance controller 11 causes the vehicle M to approach the no-passing target vehicle to cause the following distance to converge to the target following distance that is set for the no-passing target vehicle. A distance traveled by the vehicle M while the following distance is being reduced can be secured as a distance over which braking can be applied. As a result, the distance over which braking can be applied increases, and a small amount of deceleration described above is sufficient to adequately respond when the no-passing target vehicle decelerates.

Further, minimizing the target following distance enables the vehicle M to change lanes to travel immediately behind the no-passing target vehicle when a target to follow changes from the vehicle to follow (F) to the no-passing target vehicle. In addition, minimizing the target following distance enables the vehicle M traveling behind and to a side of the no-passing target vehicle to be easily visible from the no-passing target vehicle.

In the present embodiment, the target following distance at the time of following the no-passing target vehicle in the ACC is simply set to the minimum distance among the target following distances that are set in the normal ACC. Thus, control can be shared with the normal ACC on the system, and the maintainability can be improved accordingly.

In addition, the acceleration that is set in the ACC in this situation when the vehicle M is about to approach the no-passing target vehicle is set to a value smaller than the acceleration in the normal ACC. Reducing the acceleration enables the vehicle M to keep small deceleration without rapidly decelerating in responding to a situation in which the no-passing target vehicle rapidly decelerates. Consequently, the discomfort felt by the driver can be reduced.

A function of prohibiting passing provided in ACC techniques known in the art includes a parallel traveling vehicle identification process of determining whether a parallel traveling vehicle is traveling in a no-passing target lane. In a parallel traveling vehicle identification process with low accuracy, to prevent an erroneous brake operation due to low accuracy, registration as a no-passing target vehicle is performed only for a parallel traveling vehicle that is continuously traveling in a no-passing target lane for a predetermined period of time.

Thus, the ACC sets the target vehicle speed to the set vehicle speed until the parallel traveling vehicle is registered as a no-passing target vehicle in such a parallel traveling vehicle identification process known in the art. Consequently, the vehicle M is accelerated against the intention of the driver during a transition period until the parallel traveling vehicle is registered as a no-passing target vehicle. Then, when the parallel traveling vehicle is registered as a no-passing target vehicle in the parallel traveling vehicle identification process, the function of prohibiting passing is activated in the ACC, and the vehicle M is rapidly decelerated. Thus, unnecessary acceleration/deceleration control is performed.

In contrast, in the present embodiment, even when a vehicle to follow (F) traveling ahead of the vehicle M in the direction of travel disappears, the ACC immediately performs registration of the vehicle to follow (F) as a no-passing target vehicle, and the vehicle following control is performed (steps S8 and S9 described above). Thus, the ACC does not set the target vehicle speed to the set vehicle speed. Consequently, in the ACC according to the present embodiment, unnecessary acceleration/deceleration control against the intention of the driver is prevented. Further, during the time of transition until the vehicle to follow (F) is registered as a no-passing target vehicle, the vehicle M does not erroneously pass a candidate for a no-passing target vehicle.

Next, the driving assistance controller 11 checks whether the no-passing target vehicle travels in parallel in the no-passing target lane (the second lane in FIG. 3B and the third lane in FIG. 4B) for a set time interval tim or more (step S10). The set time interval tim is an elapsed time after the driving assistance controller 11 determines that the vehicle M or the vehicle to follow (F) has departed (refer to FIGS. 3B and 4B). The set time interval tim may be the same as a time interval (for example, 1 to 3 [sec]) required for the parallel traveling vehicle identification process known in the art.

When the time interval during which the no-passing target vehicle is traveling in the no-passing target lane does not reach the set time interval tim (NO), the driving assistance controller 11 returns to step S9 and continues the vehicle following control.

In contrast, upon determining that the no-passing target vehicle is continuously traveling in the no-passing target lane for the set time interval tim or more (YES), the driving assistance controller 11 updates the registration and performs registration of the no-passing target vehicle as a no-passing parallel traveling vehicle (step S11). The driving assistance controller 11 performs the ACC to cause the vehicle M to follow the no-passing parallel traveling vehicle (see FIG. 3B and FIG. 4B) while the vehicle M maintains the lane in which the vehicle M is currently traveling (step S12).

Thereafter, the driving assistance controller 11 checks whether the no-passing parallel traveling vehicle has departed from the no-passing target lane (step S13). Then, upon determining that the no-passing parallel traveling vehicle has not departed from the no-passing target lane (NO), the driving assistance controller 11 checks whether the vehicle M has departed from the no-passing lane (step S14). Upon determining that the vehicle M has not departed from the no-passing lane (step S14: NO), the driving assistance controller 11 continues the ACC in step S12.

Upon determining that the no-passing parallel traveling vehicle has departed from the no-passing target lane (step S13: YES) or upon determining that the vehicle M has departed from the no-passing lane (step S14: YES), the driving assistance controller 11 clears the registration as the no-passing parallel traveling vehicle and exits the routine. Consequently, the driving assistance controller 11 causes the vehicle M to travel in the normal ACC.

In this way, according to the present embodiment, the registration of the vehicle to follow (F) is immediately updated to the registration as a no-passing target vehicle if the vehicle M or the vehicle to follow (F) departs from the travel lane and travels in the departure section while the ACC is performed to cause the vehicle M to follow the preceding vehicle F, which is traveling ahead of the vehicle M, as the vehicle to follow (F). Accordingly, the ACC can be continued. Thus, even if the vehicle to follow (F) disappears in the departure section, unnecessary acceleration/deceleration is avoidable, and the discomfort felt by the driver can be reduced.

### Modification

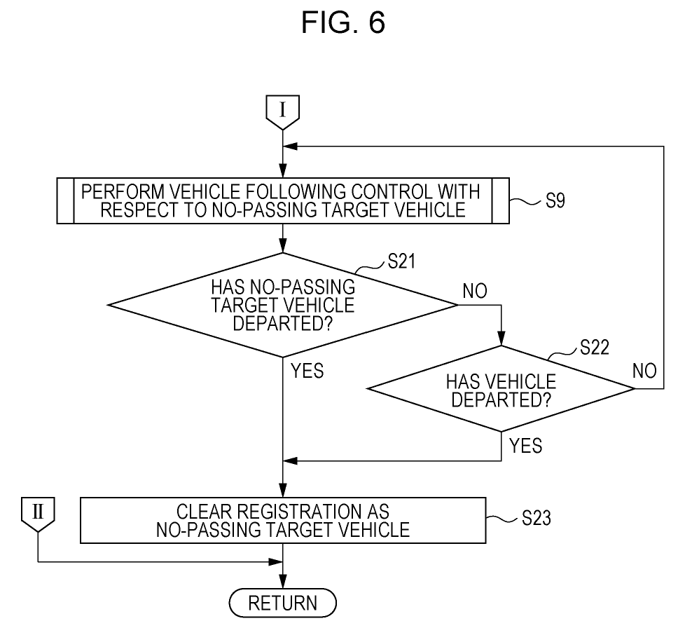

FIG. 6 illustrates a modification to the vehicle following control routine. FIG. 6 is applied in place of FIG. 2B. The processes in steps S1 to S9 are identical to the processes in the flowcharts in FIGS. 2A and 2B.

In the above-described embodiment, when the no-passing target vehicle continuously travels in the no-passing target lane for the set time interval tim or more, the registration as the no-passing target vehicle is updated to the registration as the no-passing parallel traveling vehicle, and the ACC is performed (FIG. 2B: steps S10 to S12).

In contrast, in the present modification, the processes in steps S10 to S12 are omitted. That is, in the routine illustrated in FIG. 6, the driving assistance controller 11 checks whether the no-passing target vehicle has departed from the no-passing target lane (step S21) when performing the ACC to cause the vehicle M to follow the no-passing target vehicle while keeping traveling in the lane in which the vehicle M is currently traveling (step S9).

Then, upon determining that the no-passing target vehicle has not departed from the no-passing target lane (step S21: NO), the driving assistance controller 11 checks whether the vehicle M has departed from the no-passing lane (step S22). Upon determining that the vehicle M has not departed from the no-passing lane (step S21: NO), the driving assistance controller 11 continues the ACC in step S9.

Upon determining that the no-passing target vehicle has departed from the no-passing target lane (step S21: YES) or upon determining that the vehicle M has departed from the no-passing lane (step S22: YES), the driving assistance controller 11 clears the registration as the no-passing target vehicle and exits the routine.

In this way, according to the present modification, since the processes in steps S10 to S12 in the above-described embodiment are omitted, the calculation becomes easy, and the load of the driving assistance controller 11 can be reduced.

According to the disclosure, registration of a preceding vehicle as a no-passing target vehicle is performed, and vehicle following control is performed with respect to the no-passing target vehicle when one or more of first and second states are detected based on the information regarding traveling environment acquired by the traveling environment information acquirer. The first state is that the preceding vehicle has departed to a no-passing target lane side, and the second state is that the vehicle including the ACC apparatus has departed to a no-passing lane side. Thus, unnecessary acceleration/deceleration is avoidable during a period between the disappearance of the preceding vehicle and the detection of the preceding vehicle as the no-passing target vehicle when the vehicle including the ACC apparatus or the preceding vehicle followed by the vehicle including the ACC apparatus moves to an adjacent lane. Consequently, discomfort felt by the driver can be reduced.

The driving assistance apparatus 1 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the driving assistance apparatus 1 including the driving assistance controller 11. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A driving assistance apparatus for a vehicle, the driving assistance apparatus comprising:
a traveling environment information acquirer configured to acquire information regarding traveling environment ahead of the vehicle; and
a vehicle following controller configured to, when a preceding vehicle most previously traveling in front of the vehicle in a same lane as the vehicle is detected based on the information regarding traveling environment acquired by the traveling environment information acquirer, perform a vehicle following control with respect to the preceding vehicle,
wherein the vehicle following controller comprises
a registration unit for no-passing target vehicles configured to perform, regarding the preceding vehicle, registration of the preceding vehicle as a no-passing target vehicle when one or both of first and second states are detected based on the information regarding traveling environment acquired by the traveling environment information acquirer, the first state being that the preceding vehicle has departed to a no-passing target lane side, the second state being that the vehicle has departed to a no-passing lane side, and
a no-passing target following controller configured to perform the vehicle following control with respect to the no-passing target vehicle when the registration unit for no-passing target vehicles has performed the registration as the no-passing target vehicle.

2. The driving assistance apparatus for the vehicle according to claim 1,
wherein a deceleration that is set while the no-passing target following controller performs the vehicle following control is smaller than a deceleration that is set while the vehicle following control is performed with respect to the preceding vehicle.

3. The driving assistance apparatus for the vehicle according to claim 1,
wherein a target following distance that is set while the no-passing target following controller performs the vehicle following control is a minimum distance among target following distances that are set while the vehicle following control is performed with respect to the preceding vehicle.

4. The driving assistance apparatus for the vehicle according to claim 1,
wherein an acceleration that is set while the no-passing target following controller performs the vehicle following control is smaller than an acceleration that is set while the vehicle following control is performed with respect to the preceding vehicle.

5. The driving assistance apparatus for the vehicle according to claim 1,
wherein the registration unit for no-passing target vehicles is configured to clear the registration as the no-passing target vehicle when the no-passing target vehicle has departed from the no-passing target lane or when the vehicle has departed from the no-passing lane.

6. The driving assistance apparatus for the vehicle according to claim 2,
wherein the registration unit for no-passing target vehicles is configured to clear the registration as the no-passing target vehicle when the no-passing target vehicle has departed from the no-passing target lane or when the vehicle has departed from the no-passing lane.

7. The driving assistance apparatus for the vehicle according to claim 3,
wherein the registration unit for no-passing target vehicles is configured to clear the registration as the no-passing target vehicle when the no-passing target vehicle has departed from the no-passing target lane or when the vehicle has departed from the no-passing lane.

8. The driving assistance apparatus for the vehicle according to claim 4,
wherein the registration unit for no-passing target vehicles is configured to clear the registration as the no-passing target vehicle when the no-passing target vehicle has departed from the no-passing target lane or when the vehicle has departed from the no-passing lane.

9. A driving assistance apparatus for a vehicle, the driving assistance apparatus comprising:
circuitry configured to
acquire information regarding traveling environment ahead of the vehicle; and
when a preceding vehicle most previously traveling in front of the vehicle in a same lane as the vehicle is detected based on the information regarding traveling environment, perform a vehicle following control with respect to the preceding vehicle,
wherein the circuitry is further configured to
perform, regarding the preceding vehicle, registration as a no-passing target vehicle when one or both of first and second states are detected based on the information regarding traveling environment, the first state being that the preceding vehicle has departed to a no-passing target lane side, the second state being that the vehicle has departed to a no-passing lane side, and
perform the vehicle following control with respect to the no-passing target vehicle when the registration as the no-passing target vehicle has been performed.
